(19) United States
(12) Patent Application Publication
(10) Pub. No.: US 2011/0308716 A1
(43) Pub. Date: Dec. 22, 2011

(54) Temporary fastener

(76) Inventor: David W. Peterson, San Diego, CA (US)

(21) Appl. No.: 13/130,510

(22) PCT Filed: Nov. 20, 2009
(86) PCT No.: PCT/US2009/065386

§ 371 Date: Aug. 8, 2011

Related U.S. Application Data
(60) Provisional application No. 61/116,607, filed on Nov. 20, 2008.

(51) Int. Cl. A44B 18/00; B32B 37/12

(52) U.S. Cl. 156/249; 24/304

(57) ABSTRACT

A temporary and disposable fastener (10) for securing an object to another at two spaced-apart locations comprises a slab of slow-drying, frangible adhesive (11) sandwiched between two strips of pliable sheet material (12, 13), whereby peeling said strips from each other by grasping a separating end tabs (14, 15) results in two separate sticky curls that can be interposed between said objects, in absence of any wasteful peelable seals. A manufacturing process combines a pair of commercially available patterned adhesive rolls in an aligned adhesive-to-adhesive manner which is then printed and die-cut to form a roll of adjoined separable fasteners.

This application claims the benefit of U.S. Provisional Patent Application Ser. No. 61/116,607 file 20 Nov. 2009.

### FIELD OF THE INVENTION

The present invention relates generally to pressure sensitive fasteners and more specifically two disposable fasteners used to temporarily secure objects to one another such as a napkin to clothing.

### Background

While eating, it is customary to shield one's clothing with a napkin While eating certain foods such as spaghetti or shellfish that need to be cut open, it becomes imperative to cover one's chest from stomach to neck. Restaurants will often provide bibs with strings that can be tied in the back of the neck. Most patrons find it embarrassing and demeaning to wear in a public place such an accoutrement more fitting to a young child. An alternate method is to tie one's napkin around one's neck or to tuck one corner of the napkin into one's collar. However, the small size of the napkin may leave the lower chest exposed. Bonifield proposes in U.S. Patent Publication No. 2005/0106349 an adhesive napkin assembly having a pre-applied adhesive section. However the adhesive may interfere with use of the napkin not as a bib.

It would be more suitable and convenient to be able to spread a standard napkin over the chest and secure it to the shirt or vest by means of an inexpensive, disposable and non-spotting pair of fasteners.

The instant invention results from an attempt to devise such a suitable and convenient fabric or paper fastener.

### SUMMARY

The principal and secondary objects of the invention are to provide an improved temporary fastener. These and other objects are achieved by a providing a slab of slow-drying, frangible adhesive sandwiched between two strips of pliable sheet material, whereby peeling said strips from each other results in two separate sticky curls that can be interposed as a temporary fastener between objects.

The exemplary embodiments provide a method of for temporarily securing an object to another with a disposable fastener. In some embodiments the method comprises coating one side of each of a pair of commensurate strips of pliable, lamellar material with an adhesive substance; allowing said substance to cure and form a permanent bond with a side of said strip; joining together said strips by applying their respective adhesive-coated sides to each other; pulling them in opposite directions to form a pair of curls exposing their adhesive-coated sides; applying said curls to spaced-apart locations on said first object; and, contacting said curls with said second object.

In some embodiments the securing comprises avoiding gluing a marginal section of each of said strips, therefore providing a convenient loose spot to grab and pull the strips apart.

In some embodiments the strip material preferably exhibits a lesser degree of elasticity than the adhesive.

In some embodiments, there is provided a fastener for securing an object to another at two spaced-apart locations consisting of a slab of slow-drying frangible adhesive sandwiched between two strips of pliable, lamellar material; whereby peeling said strips from each other results in two separate sticky curls.

In some embodiments there is provided a temporarily and disposable fastener for securing an object to another at two-spaced apart location, which consists essentially of: a slab of slow-drying frangible adhesive sandwiched between two strips of pliable lamellar material; wherein said strip has a lower degree of tractability than said adhesive; whereby peeling said strips from each other results in two separate sticky curls.

In some embodiments marginal section of each of said strip extends beyond said layer of adhesive; whereby said strip can be conveniently grabbed and pulled apart. In some embodiments said material exhibits a lesser degree of elasticity than said adhesive. In some embodiments said material is taken from a group consisting essentially of paper, Mylar, Cellophane, Celluloid and low-ductility materials. In some embodiments said slab comprises two layers, each having a first surfaced tightly bonded to one of said strips and a second, opposite surface loosely bonded to the other layer.

In some embodiments the fastener further comprises a plurality of separation promoting particles dispersed between said layers. In some embodiments a first of said layers is selected from a first adhesive material having a first stickiness and a second of said layers is selected from a second adhesive material having a second stickiness, wherein said first and second stickiness are different from each other. In some embodiments a first of said strips is selected from a first material and a second of said strips is selected from a second material, wherein said first and second materials are different from each other. In some embodiments said fastener is provided in absence of adhesive-covering seals.

In some embodiments there is provided said fastener in combination with a napkin wherein each of said curls is applied to a corner of said napkin.

In some embodiments there is provided a plurality of the fasteners releasably attached to one another and wound into a roll.

In some embodiments said strips are dimensioned commensurately and in peripheral boundary alignment.

In some embodiments there is provided a method for temporarily securing an object to another with a disposable fastener, said method comprising: coating one side of each of a pair of commensurate strips of pliable lamellar material with an adhesive substance; allowing said substance to cure and form a permanent bond with a side of said strip; joining together said strips by applying their respective adhesive-coated side to each other; separating said strips by pulling them in opposite direction so as to form a pair of curls exposing their adhesive-coated side; applying said curls to spaced-apart location on said first object; and contacting said curls with said second object.

In some embodiments said separating comprises imparting a traveling crease simultaneously upon both of said strips. In some embodiments said coating comprises avoiding a marginal section of each of said strips. In some embodiments said material is selected from a group consisting essentially of paper, Mylar, Cellophane, Celluloid and low-ductility materials. In some embodiments said objects comprise a napkin and the front of a garment.

In some embodiments there is provided a process for forming a roll of adjoined, separable fasteners, said process comprising: selecting first and second labelstock rolls each having a patterned adhesive layer and a pliable sheet material backing layer; combining said labelstock rolls together in an adhesive-to-adhesive manner into a combined roll; and, segmenting said combined roll into said roll of adjoined, separable fasteners. In some embodiments the step of combining comprises aligning the patterned adhesive layer of said first labelstock roll with the patterned adhesive layer of said second labelstock roll. In some embodiments the process further comprises printing on at least one exposed surface of backing layer. In some embodiments the process further comprises removing a peel layer from each of said labelstock rolls prior to said step of combining.

### BRIEF DESCRIPTION OF THE DRAWINGS

FIG. 1 is a perspective view of a dual fastener according to the invention;

FIG. 2 is a partial longitudinal cross-section thereof;

FIG. 3 is a partial longitudinal cross-section of an alternate embodiment of the dual fastener having an intermediate separation-promoting particle layer;

FIG. 4 illustrates the process of splitting the fastener;

FIG. 5 illustrates one of the resulting curls;

FIG. 6 illustrates application of the fastener;

FIG. 7 illustrates a manufacturing process for creating a roll of adjoined fasteners from a pair of rolls of commercially available labelstock;

FIG. 8 is perspective view of a number of adjacently attached fasteners on a dispensing roll;

FIG. 9 illustrates a reduced zone of perforation between adjacently attached fasteners;

FIG. 10 illustrates promotional use of the fasteners;

FIG. 11 shows a non-oblong type of fastener; and,

FIG. 12 describes a variety of fastener configurations.

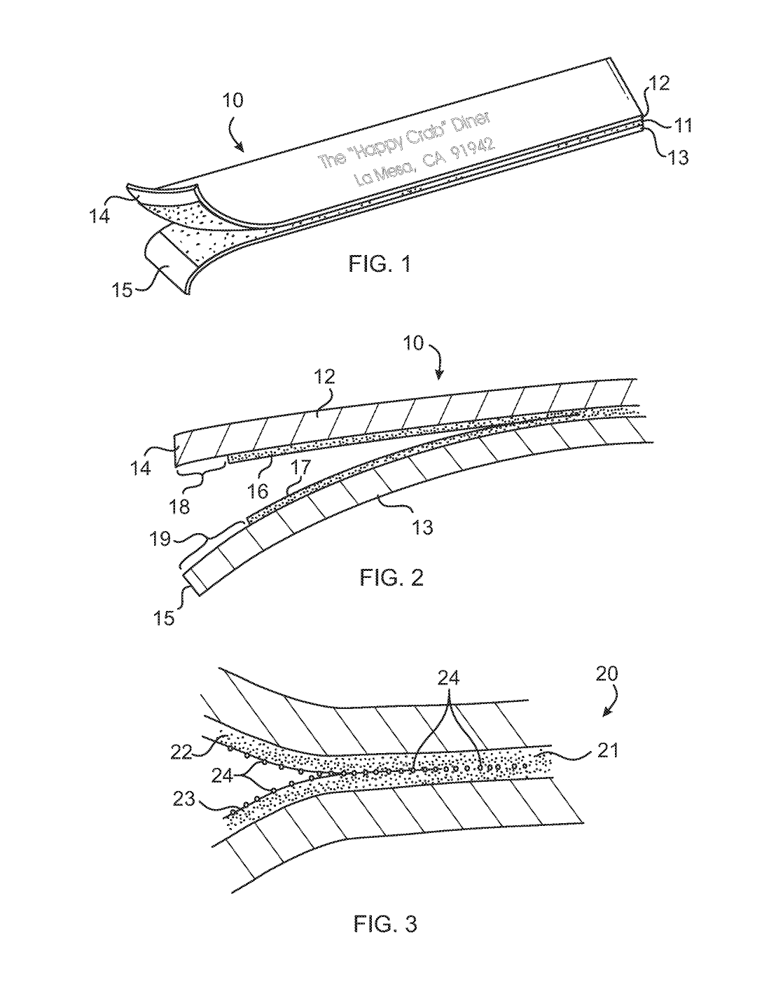

### DESCRIPTION OF THE EXEMPLARY EMBODIMENTS

Referring now to the drawing there is shown an exemplary embodiment of a dual fastener 10 according to the invention. The fastener comprises a slab 11 of slow-drying, frangible adhesive sandwiched between two strips 12, 13 of pliable, lamellar material. The strips 12, 13 may be made of paper or any other pliable material of low-ductility, i.e. not easily tractable or stretchable such as a polyester film such as Mylar, or Cellophane or Celluloid.

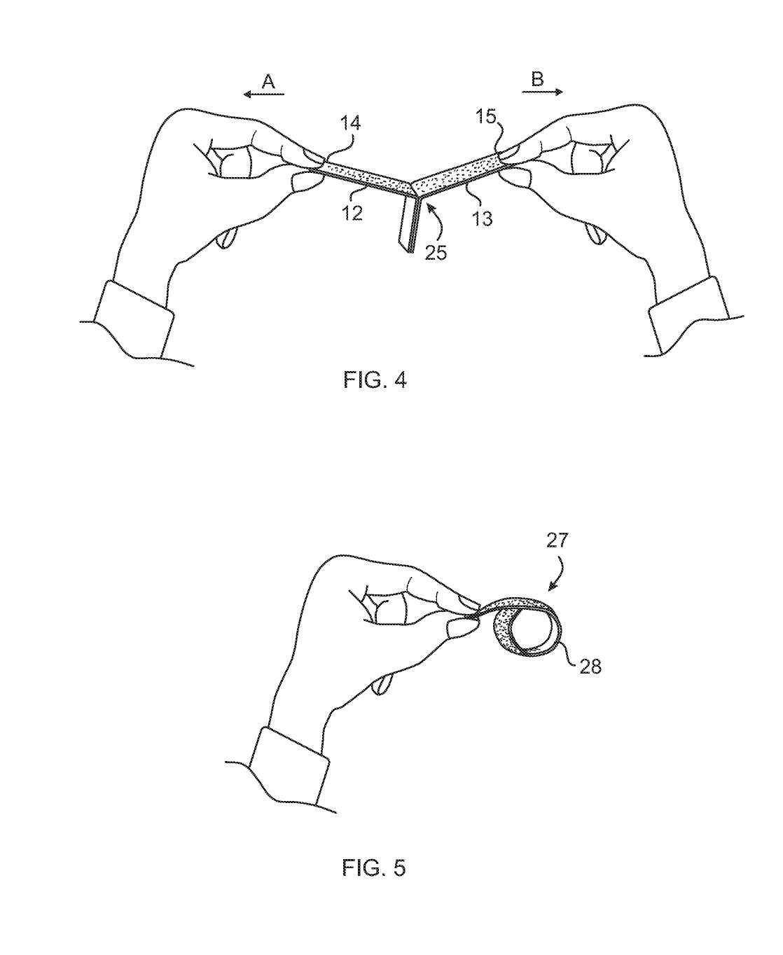

A marginal portion 14, 15 at one end of each strip extends beyond the slab 11 of adhesive, providing two face-to-face tabs without adhesive that may be grabbed, as illustrated in FIG. 4, to pull apart the strips and break the frangible slab of adhesive.

As more specifically illustrated in FIG. 2, each strip 12,13 is preferably individually coated on one side with a layer of an adhesive substance 16,17 which is first allowed to cure and tightly bond to the respective strip. The two generally commensurately dimensioned strips are then joined together in peripheral boundary alignment by contacting their respective adhesive-coated sides to each other forming a bond between the two layers of adhesive substance that is easily breakable. In other words, the adhesive slab can be characterized as a pressure-sensitive adhesive that splits cohesively and lamellarly when pulled apart creating a separate adhesive layer on each strip. The peripheral boundary alignment minimizes the amount of adhesive exposed along the peripheral edges of the fastener while the strips are bonded together. After the strips have been brought together, they form a fastener having two substantially planar outer layers that are substantially parallel with one another.

It has been found that making one strip 13 slightly longer than the other 12 while keeping the dimensions of the two adhesive layers 16,17 substantially the same allows for one tab 15 to be slightly longer in length 19 than the other tab 14 which is shorter in length 18. This arrangement helps the user locate and grasp the longer tab 15 and bend it away from the other tab 14 to more easily grasp it and thus initiate the separation of the strips. Further, graspable tabs can be formed at both ends of the fastener to give users the convenient option of peeling from either end.

Alternately, the two adhesive substance layers 16, 17 can be selected from different adhesive substances which each provide good adhesion to the strip material but a lesser adhesion to one another. In this way the bond formed between the layers is more easily or predictably broken.

Alternately, as shown in FIG. 3, the fastener 20 can have a frangible adhesive slab 21 made from a pair of adhesive layers 22,23 bonded along an interface containing a number of dispersed separation-promoting particles 24 such as talcum powder particles. The presence of these particles promote the separation of the layers and discourage the increase in the bond strength between the layers over time. Thus, the particles encourage the frangibility of the slab, thereby increasing shelf-life of the fastener. Care should be taken to avoid dense packing of the particles which could diminish the strength of the bond to a degree where the critical deformation of the adhesive layers, described below, is severely impacted.

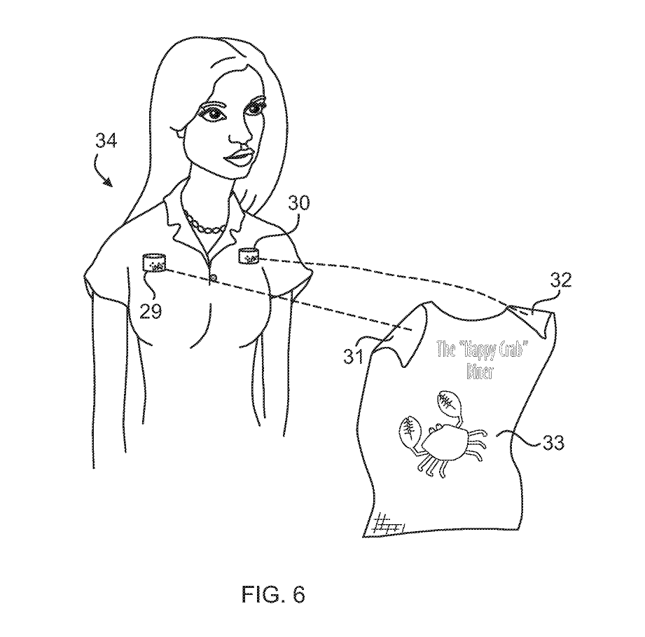

As shown in FIG. 4-5, when the strips 12, 13 are pulled apart in opposite directions A, B, the relative ductility or tractability of the adhesive compared to the lesser or lack of the same of the strip material causes each of the separated strips to form a curl 27 with the adhesive coated sides 28 exposed. In other words, the act of separation and overcoming the adhesive bond between the layers, causes a crease 25 to travel simultaneously along the longitudinal length of the strips, from the end having the marginal portions 14,15 to the opposite end. Consequently, the passage of the traveling crease causes both adhesive layers to automatically undergo an amount of longitudinal deformation relative to the strip backing, which imparts curling forces on the separated portions of the fastener.

It should also be noted that during the strip separation process the paper or other material of the strip, which exhibits less elasticity than the layer of adhesive, is forcefully bent and deformed by a longitudinally traveling crease, thus contributing to the curling action. Because Mylar as less deformable than for example paper, the adhesive used with Mylar should exhibit good ductility or tractability.

As shown in FIG. 6, the curls can be flattened and applied to two spaced apart locations 29, 30 such as in this case the shoulders of the a dining person 34. The upper corners 31, 32, of a napkin 33 can then be pressed against the fasteners in order to temporarily secured the napkin and protect the chest of the individual.

It should be appreciated that when the napkin is removed, the two fastening curls can be conveniently pulled off the garment and disposed of without leaving any spot on the garment. In this way reusable fabric napkins can be used in addition to or instead of disposable ones made of paper.

It should be appreciated that the dual fasteners can be provided as a unitary device in absence of removable waste portions such as peelable wax paper adhesive covering seals such as those often found on adhesive bandages.

The slab of adhesive is preferably continuous and uniformly thick, having a thickness of between about 2.5 micrometer (0.1 mil) and about 125 micrometer (5.0 mil); more preferably between about 12.5 micrometer (0.5 mil) and 75 micrometer (3.0 mil); and most preferably about 25 micrometer (1.0 mil). This thickness strikes a balance between less adhesive material on the one hand and enough material to cause an adequate bending force and resistence to frangibility on the other.

It has been found that each strip can be formed from a portion of FASSON brand 3 Mil White MDO/S692N/40#BG labelstock, commercially available form Avery Dennison Corporation, of Pasadena, Calif. When ordered as a patterned adhesive labelstock regions of the labelstock are left “ungummed”, in other words, lacking in adhesive. Part of these regions become the marginal portions of the strips that form the face-to-face graspable tabs.

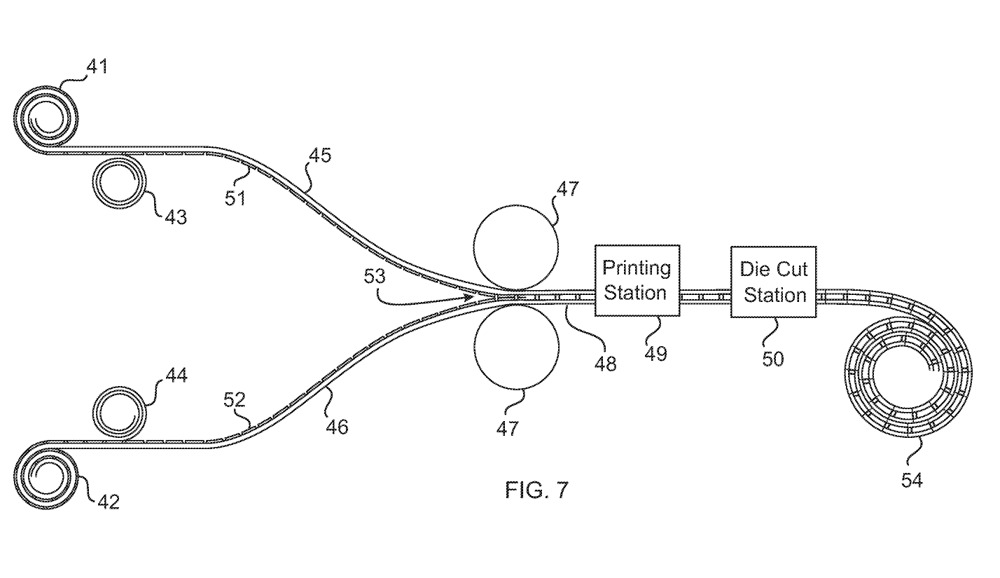

As shown in FIG. 7, a pair of patterned adhesive lablestock spools 41,42 are selected and prepared to run out such that their adhesive sides 51,52 will face one another. For both spools, a covering layer 43,44 is first removed to expose the adhesive side. The coverless runs 45,46 are brought together in alignment 53 between a pair of counter-rotating pressing rollers 47 so that the adhesive regions contact one another to form a single combined run 48 having frangible slow-drying adhesive sandwiched between a pliable backing layers. Care must be taken to properly align and guide the registration of the two labelstock runs so that the adhesive regions properly line up with one another. The single combined run 48 is fed through a printing station 49 to create printing on one or both sides. After printing the combined run is then fed through a segmenting cutting die to form the adjoined fasteners. A so-called “ticked die” 50 is used to cut the perforations. The adjoined and perforated fasteners are then wound on a dispensing roll 54.

FIG. 8 illustrates a dispensing roll 54 of adjoined fasteners 10 separated by lines of perforation 55 for easy detachment.

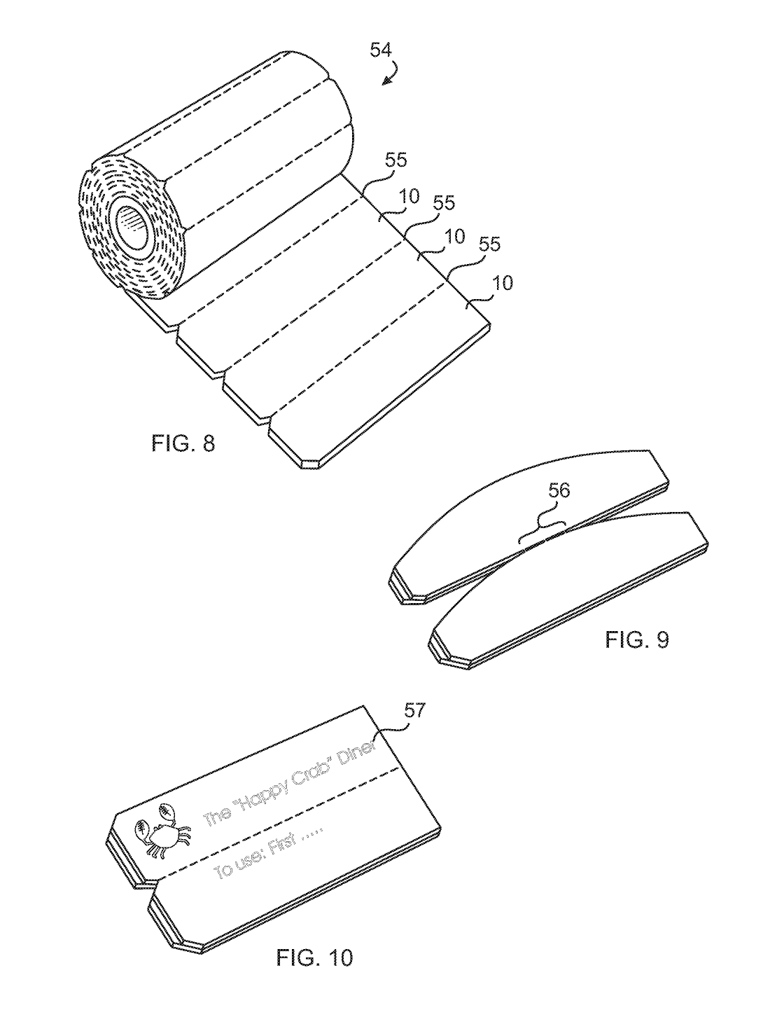

As shown in FIG. 9, the strips can be shaped to reduce the length perforation zone 56 so that adjacent fasteners may be more easily separated. In addition, because the central region of the strip is wider, when the strip curls up, there is more exposed adhesive near the non-adhesive graspable tab. In this way, should a user choose to rely on the adhesiveness near the tab, the tape loop can adequately function.

As shown in FIG. 10, a food establishment may print advertising 57 or instructions on how to use the fastener on each individual fastener or on pairs thereof.

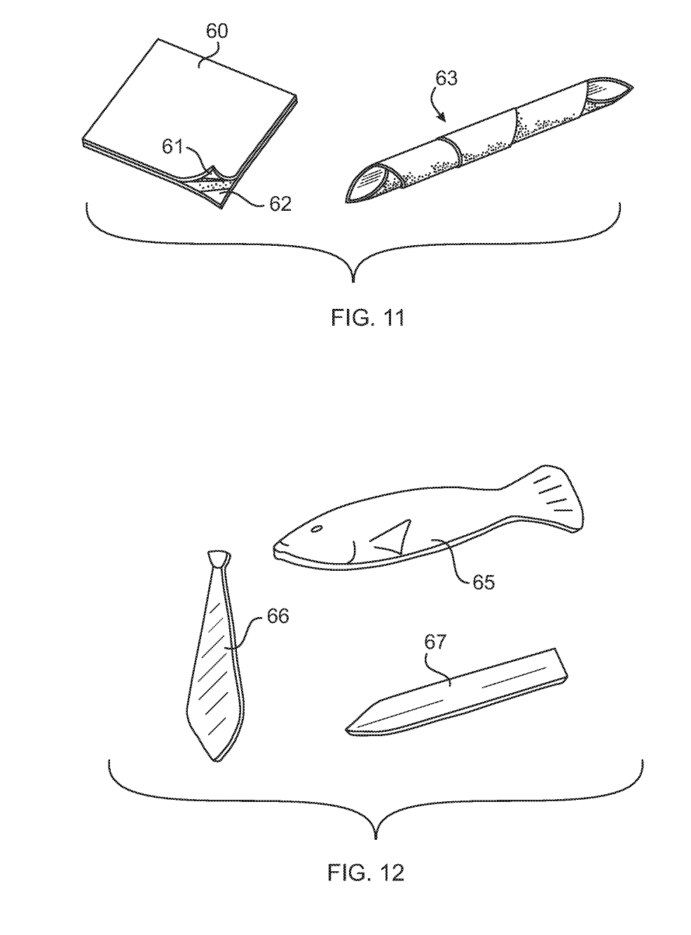

As shown in FIG. 11, the strips need not be oblong, but can assume any shape such as a square 60 with pull tabs 61,62 that are preferably placed at a corner. In such a case, the curl may assume an oblong tubular shape 63.

As shown in FIG. 12, the strips themselves may be provided in a variety of whimsical shapes 65, 66, 67. Such flexibility in shape design provides enhanced marketing opportunities to sellers.

### EXAMPLE

A pair of flexible strips measuring about 75 millimeter (3 inch)×20 millimeter (0.75 inch) are formed from a paper sheet of about 50 micrometer (2.0 mil) thick. A layer of pressure-sensitive, repositionable adhesive about 25 micrometer (1.0 mil) thick is deposited on one side of each strip. The strips are then brought together so that the adhesive layers contact one another. A slight compression force is applied to the exposed front and back surfaces of the combined fastener to form the frangible bond between the adhesive layers.

While the exemplary embodiments of the invention have been described, modifications can be made and other embodiments may be devised without departing from the spirit of the invention and the scope of the appended claims.

What is claimed is:

1. A temporarily and disposable fastener for securing an object to another at two-spaced apart location, which essentially consist of:
a slab of slow-drying frangible adhesive sandwiched between two strips of pliable lamellar material;
wherein said strip has a lower degree of tractability than said adhesive;
whereby peeling said strips from each other results in two separate sticky curls.

2. The fastener of claim 1, wherein a marginal section of each of said strip extends beyond said layer of adhesive;
whereby said strip can be conveniently grabbed and pulled apart.

3. The fastener of claim 1 wherein said material exhibits a lesser degree of elasticity than said adhesive.

4. The fastener of claim 3, wherein said material is taken from a group consisting essentially of paper, Mylar, Cellophane, Celluloid and low-ductility materials.

5. The fastener of claim 2, wherein said slab comprises two layers, each having a first surfaced tightly bonded to one of said strips and a second, opposite surface loosely bonded to the other layer.

6. The fastener of claim 5, which further comprises a plurality of separation promoting particles dispersed between said layers.

7. The fastener of claim 5, wherein a first of said layers is selected from a first adhesive material having a first stickiness and a second of said layers is selected from a second adhesive material having a second stickiness, wherein said first and second stickiness are different from each other.

8. The fastener of claim 7, wherein a first of said strips is selected from a first material and a second of said strips is selected from a second material, wherein said first and second materials are different from each other.

9. The fastener of claim 1, wherein said fastener is provided in absence of adhesive-covering seals.

10. The combination of fastener of claim 1, with a napkin wherein each of said curls is applied to a corner of said napkin.

11. A plurality of the fastener of claim 1, releasably attached to one another and wound into a roll.

12. The fastener of claim 1, wherein said strips are dimensioned commensurately and in substantial peripheral boundary alignment.

13. A method for temporarily securing an object to another with a disposable fastener, said method comprising:
coating one side of each of a pair of commensurate strips of pliable lamellar material with an adhesive substance;
allowing said substance to cure and form a permanent bond with a side of said strip;
joining together said strips by applying their respective adhesive-coated side to each other;
separating said strips by pulling them in opposite direction so as to form a pair of curls exposing their adhesive-coated side;
applying said curls to spaced-apart location on said first object; and
contacting said curls with said second object.

14. The method of claim 13, wherein said separating comprises imparting a traveling crease simultaneously upon both of said strips.

15. The method of claim 13, wherein said coating comprises avoiding a marginal section of each of said strips.

16. The method of claim 13, wherein said material is selected from a group consisting essentially of paper, Mylar, Cellophane, Celluloid and low-ductility materials.

17. The method of claim 13, wherein said objects comprise a napkin and the front of a garment.

18. A process for forming a roll of adjoined, separable fasteners, said process comprising:
selecting first and second labelstock rolls each having a patterned adhesive layer and a pliable sheet material backing layer;
combining said labelstock rolls together in an adhesive-to-adhesive manner into a combined roll; and,
segmenting said combined roll into said roll of adjoined, separable fasteners.

19. The process of claim 18, wherein said combining comprises:
aligning the patterned adhesive layer of said first labelstock roll with the patterned adhesive layer of said second labelstock roll.

20. The process of claim 18, wherein said process further comprises:
printing on at least one exposed surface of backing layer.

21. The process of claim 18, which further comprises:
removing a peel layer from each of said labelstock rolls prior to said step of combining.
